(19) United States
(12) Patent Application Publication
(10) Pub. No.: US 2015/0236531 A1
(43) Pub. Date: Aug. 20, 2015

(54) RECHARGING OF A POOL OF BATTERIES

(71) Applicant: COMMISSARIAT A L'ENERGIE ATOMIQUE ET AUX ENERGIES ALTERNATIVES, Paris (FR)

(72) Inventors: Hervé Guillou, Paris (FR); Duy Long Ha, Chambery Le Vieux (FR); Mireille Jacomino, Echirolles (FR); Van-Dat Cung, Grenoble (FR)

(73) Assignee: COMMISSARIAT A L'ENERGIE ATOMIQUE ET AUX ENERGIES ALTERNATIVES, Paris (FR)

(21) Appl. No.: 14/426,038

(22) PCT Filed: Sep. 4, 2013
(86) PCT No.: PCT/EP2013/068208

§ 371 Date: Mar. 4, 2015

(30) Foreign Application Priority Data
Sep. 5, 2012 (FR) 1258262

(51) Int. Cl. H02J 7/00; H02J 7/35

(52) U.S. Cl. CPC H02J 7/0013; H02J 7/0052; H02J 7/35

(57) ABSTRACT

The method for managing the charging of a pool of batteries on the basis of a charging system (1) having several charging terminals (2) supplied electrically from at least one energy production source (5, 6), includes: initializing a recharging date for each battery, defining a neighbourhood (E12) including a set of recharging dates in proximity to a previously employed recharging date, computing the performance (E13) of a new solution obtained by replacing the previously employed recharging date with recharging dates in the defined neighbourhood, storing the recharging date which gives the best performance subsequent to the performance computation (E13) and replacing the previously employed recharging date with this new recharging date, testing an end-of-computation criterion (E20), and if the criterion is not attained, performing a new iteration of defining, computing and storing and replacing steps while considering a neighbourhood of reduced duration with respect to the previous iteration.

The invention relates to a method for managing the charging of a pool of batteries implemented at the level of a charging system supplied by at least one energy source. It also pertains to a battery charging system as such implementing such a method.

Numerous devices exist which operate with the aid of a rechargeable battery, such as for example electric or hybrid automotive vehicles. When the user of such an electrical device realizes that the charge of his battery is too low, he links it to a recharging system which utilizes as input the power provided by an electrical energy source so as to transmit as output a current for recharging the battery.

When the electrical device concerned is an electric vehicle, the battery recharging system can take the form of a shelter defining a parking place and equipped electrically for electrical connection with the battery. Such a shelter can be equipped with photovoltaic panels generating electrical energy which is used to recharge the vehicle battery. In practice, the driver positions his vehicle under the shelter, connects it electrically to a power socket arranged at the level of the shelter, the effect of which is to immediately initiate the recharging of his vehicle battery. The recharging phase is thereafter halted automatically by the recharging system as soon as the battery attains its full charge.

Existing recharging systems are not optimized. Indeed, the recharging of the various batteries is in general initiated as soon as they are connected electrically with the system, with the objective of charging them fully. However, this recharging may require energy originating from an expensive and/or polluting electricity production source when recharging the battery. Moreover, this energy source may be insufficient at a given instant, in particular if too many batteries are on charge simultaneously and/or if renewable energy sources are used, such as a solar or wind-driven source, the nature of which is to fluctuate.

To alleviate these drawbacks, document FR2952247 proposes a planning of the recharging of the batteries of electric vehicles on the basis of the knowledge of their date of departure and of a desired level of charge.

Document U.S. Pat. No. 5,548,200 proposes to determine the choice of the electrical conditions and the moment of recharging so as to optimize the cost of the recharge, during off-peak periods for example.

Existing solutions remain insufficient to best utilize a recharge of a pool of batteries in a situation where the batteries arrive in a random manner at the level of a given recharging system, which utilizes the electrical power originating from at least one intermittent or simply discontinuous or rare energy source, to supply these recharges, this source possibly varying in a more or less unforeseeable way, such as sources of photovoltaic or wind-driven energy.

Moreover, the solutions must be suitable for a charging system that can accommodate a large number of vehicles, for which the algorithms for optimizing the recharging of the batteries run the risk of being saturated and unsuitable, since the computation for optimizing the method for managing the charging of the vehicles is carried out upon each entry and/or exit of a vehicle. Thus, it is necessary to define a method for managing the charging of electric vehicles which makes it possible to converge rapidly to a solution with the aid of a reasonable and not too expensive computational power, so as to be appropriate for managing a pool that may comprise a large number of batteries, for managing for example at least 100 000 vehicles (or batteries) or at least 1 million vehicles (or batteries).

Ultimately, a need therefore exists for an improved solution for the intelligent management of the recharging of a pool of batteries that may comprise a large number of batteries, which is compatible with the use of an intermittent energy source and more generally on the basis of an energy source that is not available continuously. For example, such an energy source may be of solar or wind-driven type as mentioned previously, or could be a national electrical grid whose use should be optimized and reduced, so as to comply with constraints on cost or local provision for example.

A general object of the invention is therefore to propose a solution for optimized management of the recharging of a pool of batteries, which meets the objectives mentioned hereinabove and does not comprise all or some of the drawbacks of the prior art solutions.

More precisely, a first object of the invention is to propose a solution for recharging a pool of batteries making it possible to converge rapidly to an optimized solution so as to be able to process a large number of batteries which enter and exit a charging system according to a significant and arbitrary frequency.

A second object of the invention is to propose a solution for recharging a pool of batteries preferably using a certain chosen energy source, which may be intermittent.

A third object of the invention is to propose a solution for recharging a pool of batteries which is compatible with a random arrival of batteries at recharging terminals.

For this purpose, the invention rests upon a method for managing the charging of a pool of batteries on the basis of a charging system comprising several charging terminals supplied electrically from at least one energy production source, characterized in that it comprises the following steps:
a. Initialization of a recharging date for each battery of the battery pool, and then in that it comprises the following steps for a battery under consideration:
b. Definition of a neighbourhood comprising a set of recharging dates in proximity to the recharging date previously employed for the battery under consideration,
c. Computation of the performance of a new solution obtained by replacing the recharging date previously employed for the battery under consideration with recharging dates included in the neighbourhood defined in the previous step, and then
d. Storage of the recharging date which gives the best performance subsequent to the performance computation of the previous step and replacement of the previously employed recharging date with this new recharging date which gives the best performance, and then in that it comprises the following steps:
e. Testing of an end-of-computation criterion,
f. If the end-of-computation criterion is not attained, new iteration of steps b to d hereinabove while considering a neighbourhood of reduced duration with respect to the previous iteration for a battery under consideration.

A neighbourhood is advantageously formed by a temporal space comprising a few elementary time intervals extending around the recharging date previously employed for the battery under consideration. Each elementary time interval can be associated with a possible recharging date. At each iteration, the neighbourhood can comprise an ever smaller duration, by way of elementary time intervals defined so as to form this ever shorter duration.

Steps b to d can be repeated for all the batteries of the pool of batteries, or indeed for a multitude of batteries. These steps can be repeated for this multitude of batteries at one and the same instant, to define an overall solution.

A neighbourhood can be a temporal space extending around the recharging date previously employed and comprise fewer than 10 recharging dates to be tested, and/or the various recharging dates of the neighbourhood can be successive and separated according to a given time span and/or be chosen randomly in the neighbourhood, and/or the various possible charging dates of the neighbourhood can be distributed on either side of the previously employed recharging date and comprise this previously employed recharging date.

The method for managing the charging of a pool of batteries can comprise a step of computing the performance of a new solution which takes into account the proportion of energy used originating from one or more sources of renewable energy, such as a photovoltaic and/or wind-driven source, and/or the overall cost of the energy used.

The method for managing the charging of a pool of batteries can comprise a step of computing a prediction of renewable energy production by a photovoltaic or wind-driven renewable energy source of the charging system.

The step of initializing a recharging date for each battery of the battery pool can consist in choosing as initial value the date of arrival in the charging system of each battery.

The method for managing the charging of a pool of batteries can comprise a prior phase of storing all or some of the following parameters:
the number of batteries present in the charging system at a given instant;
the charging profile of each battery;
the state of charge of each battery;
an earliest and/or latest recharging date for each battery;
a duration, over which it is sought to optimize the charge of the batteries present;
a number of periods, which makes it possible to discretize the time over this duration under consideration;
an accuracy, in the form of an integer number of periods;
a time slicing, which allows a more or less significant slicing of a duration under consideration;
a formula for computing the performance.

The method for managing the charging of a pool of batteries can comprise the following steps:
Estimation of the future energy production by at least one energy source, i.e. the predicted energy E_{predicted} and the predicted power P_{predicted}(t) as a function of time t, in the course of a reference period, by at least one energy production source;
Estimation of the energy need Σᵢ Eᵢ(t) for the recharging of the batteries present in the charging system;
Computation of a dummy power P_{dummy} less than or equal to the predicted power and able to meet all or part of this energy need in a dummy period distinct or not from the reference period;
Planning of the recharges of the batteries present in the charging system over this dummy period.

The test of an end-of-computation criterion can comprise all or some of the following tests:
the performance of the solution obtained is greater than or equal to a predefined threshold; and/or
the number of iterations attains a predefined threshold; and/or
the time slicing carried out on the basis of the time span attains a predefined threshold; and/or
the duration of a neighbourhood is less than a predefined threshold; and/or
the duration between two intervals distributed around the previously employed recharging date is less than a predefined threshold; and/or
the number of iterations without improvement of the performance attains a predefined threshold.

The method for managing the charging of a pool of batteries can thereafter comprise a step of charging each battery of the charging system according to a chosen charging profile, from a start-of-charging date deduced directly or indirectly from the recharging date computed by the method after the end-of-computation criterion is attained.

Steps a to f can be implemented on each entry and/or exit of a battery of the charging system.

The invention also pertains to a system for charging a pool of batteries comprising several charging terminals supplied electrically from at least one energy production source, characterized in that it comprises a central unit which implements the method for managing the charging of the pool of batteries such as described above.

The system for charging a pool of batteries can comprise a solar and/or wind-driven renewable energy production source.

The charging terminals of the system can be disposed on parking places for the recharging of a pool of batteries of electric automotive vehicles.

The system for charging a pool of batteries can comprise a central server, this central server being linked to the central unit of a charging system by at least one communication means.

These objects, characteristics and advantages of the present invention will be set forth in detail in the following description of a particular mode of execution given without limiting effect in conjunction with the attached figures among which:

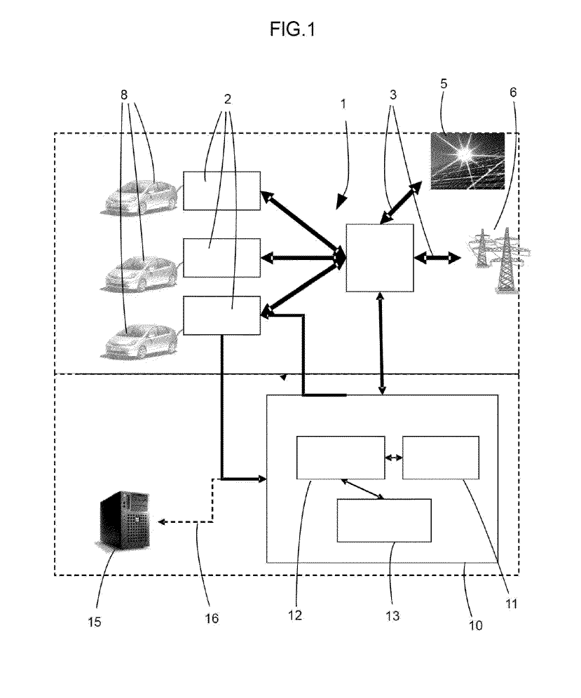

FIG. 1 schematically represents a battery charging system implementing the method for recharging batteries according to an embodiment of the invention.

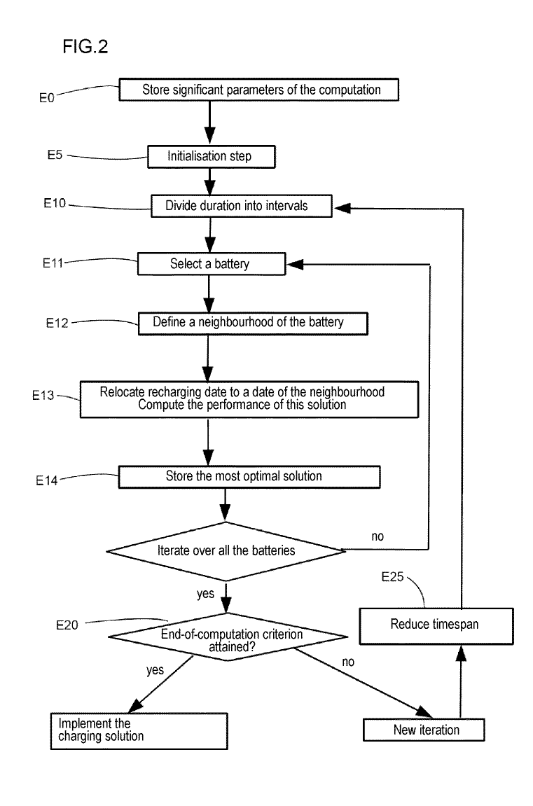

FIG. 2 represents an algorithm of a method for managing the recharging of batteries according to the embodiment of the invention.

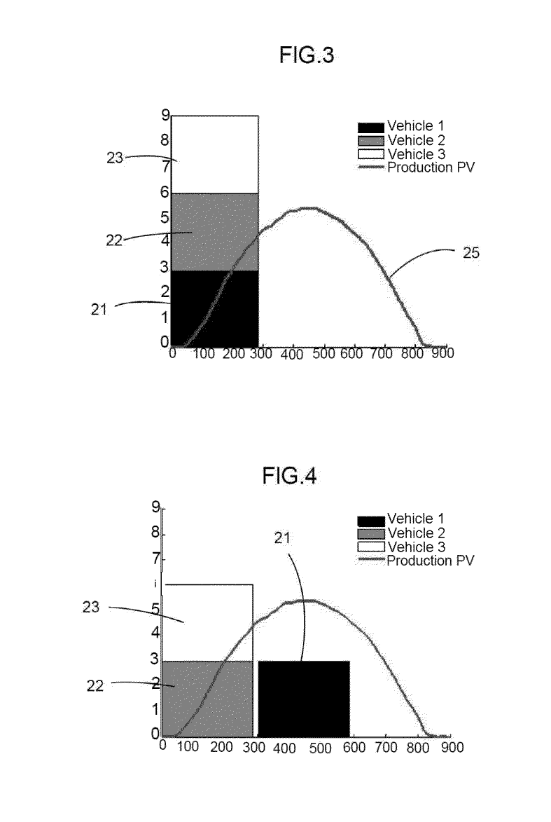

FIGS. 3 to 11 illustrate the implementation of the algorithm of a method for managing the recharging of batteries according to the embodiment of the invention within the framework of a particular scenario by way of example.

The invention will be illustrated in the case of a pool of electric vehicles by way of example. Such an electric vehicle may be an electric bike, an electrical car, a segway, an electric scooter, etc. Naturally, the invention could be readily transposed to any electrical device equipped with a battery for its power supply, and requiring phases of recharging of its battery. Moreover, for simplification reasons, it will be considered in the following description that each vehicle is equipped with a single battery. However, the method could naturally be applied in a manner similar to vehicles equipped with several batteries. This is why the invention is more generally concerned with the problem of the recharging of a pool of batteries, in particular in the case of a large number of batteries and where their use is random and does not make it possible to accurately ascertain individually the times at which it will be necessary to recharge them.

FIG. 1 illustrates a system for charging batteries according to an embodiment. This system comprises a charging device 1 comprising various charging terminals 2, to which batteries of vehicles 8 can be connected electrically for the implementation of their recharging. The charging device 1 is linked to one or more electrical energy production sources 5 by an electrical link 3, these sources being renewable and intermittent, such as of photovoltaic or wind-driven type, in this particular example, and linked in an optional manner to a traditional electrical grid 6 so as to cope with possible inadequacies of the above sources. The objective is naturally not to resort to the traditional electrical grid 6 so as to avoid saturating it and to profit from the less polluting and renewable sources 5 of energy production at the disposal of the recharging device 1. The latter can thus take the form of a parking facility, each place of which is equipped with a battery recharging terminal supplied by photovoltaic panels disposed for example on a roof of the parking facility.

The charging system comprises moreover a central unit 10, which comprises software and hardware means for driving the charging device 1, so as to implement the recharging method which will be detailed hereinafter. This central unit 10 thus comprises in particular the intelligence of the charging system, in the form of any type of computer. It comprises in particular a prediction module 11 which implements a computation for predicting the production of electricity, in particular that available on the basis of the intermittent energy sources 5. It also implements a computation for predicting the evolution of the price of the electricity originating from the grid 6 or other permanent sources, and a computation for predicting the arrival and/or the departure of the electric vehicles. This prediction module can operate in a local and autonomous manner and/or on the basis of information, and/or of computations, carried out remotely on a server 15 and linked to the central unit 10 by a communication means 16. The central unit 10 comprises moreover an optimization module 12 which comprises the functions and the algorithms making it possible to define in an automatic manner when and how each battery connected to the charging system 1 must be recharged. It also comprises a local database 13 which allows the storage of the data relating to the batteries to be charged, data representing the state of the charging system, logs of the past operations, etc.

The charging system is optionally linked to a central server 15, as mentioned hereinabove, by one or more communication means 16. This central server 15, which can be linked to several systems for charging batteries, receives information such as data of meteorological forecasts for example, and can participate in all or some of the computations necessary for the operation of a charging system. Preferably, the latter is relatively autonomous, or indeed totally autonomous, and implements a method for managing the charging of the batteries with the aid of a simple and fast computation, implemented on a computer comprising limited computation means.

As a variant, this charging system can utilize any energy source other than those mentioned, according to an arbitrary number. Moreover, the management method which defines its operation can be implemented by a remote or local central unit, in cooperation or not with a remote server 15, with arbitrary computational power.

We shall now describe in conjunction with FIG. 2 an embodiment of a method for managing the charging of a pool of batteries, implemented by the charging system described hereinabove.

The method comprises a prior phase E0 of defining and storing significant parameters, used by the future optimization computation implemented by the method.

In one embodiment, among the parameters considered during this prior phase, first parameters listed hereinbelow relate firstly directly to the batteries involved:
The number of vehicles present in the charging system at a given instant, that is to say the number of batteries to be charged;
The charging profile of each battery, such as provided by the maker of the battery for example;
The state of charge of each battery;
An earliest and/or latest recharging date for each battery.

These first parameters can be automatically transmitted by the onboard computer of each vehicle when it enters the charging system, by any remote means of communication with the central unit for example, and/or at least in part by an intentional action of the driver of the vehicle.

Thereafter, second parameters relate directly to the optimization computation which will be performed. These second parameters are for example input by a manager of the system for charging batteries, by way of a man machine interface associated with the central unit 10 of the system. They allow it to perform an adjustment of the method implemented, to choose for example a compromise between computation time and the performance of the result. As a variant, default parameters may be used. These second parameters are from among:
A duration, over which it is sought to optimize the charge of the batteries present, for example a day;
A number of periods, which makes it possible to discretize the time over this duration under consideration. A period may for example be of the order of a minute or a second. Advantageously, the period will be chosen so that each charging profile of the batteries represents an integer multiple of periods;
An accuracy, which represents the accuracy desired when planning the charging of the batteries. This accuracy can take the form of an integer number of periods. This parameter makes it possible to choose a compromise between desired accuracy and computation time, as will be apparent subsequently;
A time slicing p, which allows a more or less significant slicing of a duration under consideration, such as will be explained subsequently.

Finally, third parameters refer to the environment and to the search for performance of the charging system. In particular, a performance criterion is defined in this prior phase, which serves to determine whether a certain solution should be deemed better than another. This criterion takes into account in particular the percentage of renewable energy used overall for charging all the batteries, while complying with imposed dates.

Various alternative embodiments can naturally be defined, by considering all or some of the parameters mentioned explicitly hereinabove or other parameters.

Thereafter, a second phase of the method consists of an optimization computation which makes it possible to culminate in a solution making it possible to define the efficacious recharging of the set of batteries of the charging system, according to a certain predefined performance criterion, mentioned hereinabove.

According to this embodiment, the method for managing the recharging of the batteries computes a variable which corresponds to the instant of the start (or indeed of the end) of the charging of each battery present in the recharging system, more generally called the recharging date. Naturally, any other date characteristic of the organization of the battery recharges can serve as variable of the method, or indeed any other value which makes it possible to define the modalities of the recharging, therefore indirectly a recharging date. Thereafter, provided that the charging is instigated for a given battery at the date determined by the method, this charging is fully executed by applying the charging profile of the given battery.

This second phase proceeds by implementing a certain number of iterations, which make it possible to converge to an optimal solution.

Accordingly, a computation initialization step E5 is firstly carried out by inputting an arbitrary initial value for each recharging date for each battery of the charging system. As a variant, an initial value favourable to the computation can be chosen, such as the date of arrival into the charging system of each battery.

Thereafter, the total duration under consideration is divided into a certain number of elementary time intervals, in a step E10 that is repeated for each iteration, making it possible to consider at each iteration a new ever smaller time span. Accordingly, the time slicing coefficient p is used. As a variant, this slicing is not carried out in this distinct step E10, which is therefore optional, but subsequently when defining the neighbourhoods.

Thereafter, the following steps are carried out:

As first step E11, a given battery is selected. Since the steps described hereinbelow are carried out for all the batteries, they can be selected successively one after the other, in an arbitrary order, which may be the order of arrival of the batteries for example. As a variant, they can be processed by decreasing energy (or state of charge).

As second step E12, a neighbourhood of the battery is defined. This neighbourhood is defined as a temporal space extending around the recharging date stored at the previous iteration for this battery, and comprising a maximum of a few elementary time intervals disposed around the recharging date.

In this embodiment, the neighbourhood comprises elementary intervals distributed in equal share before and after the recharging start date, for example p elementary intervals before and two after. Naturally, the neighbourhood is also bounded by the overall duration under consideration, within which we remain, and by the earliest and latest recharging start dates input for the battery under consideration. This neighbourhood therefore comprises a chosen number of intervals, each interval being delimited by dates of intervals, for example a start date of each interval, these dates being distributed in proximity, in the neighbourhood of the previously selected and stored recharging date for a battery under consideration.

More generally, a neighbourhood therefore corresponds to a set of recharging dates (or any other variable that the method seeks to define), which are to be tried, distributed in proximity to a previously selected recharging date, for example distributed before and/or after this recharging date, and following one another according to a time span defined for this iteration under consideration. This neighbourhood therefore makes it possible not to test all the solutions over the whole of the duration under consideration, which would entail a more unwieldy computation, but to restrict oneself to a smaller number of possibilities, positioned in proximity to a solution already envisaged at an instant of the computation. Advantageously, this neighbourhood thus comprises a number less than 10 possibilities, advantageously equal to 2 possibilities.

As a variant, the neighbourhood can be defined as any temporal space extending around the recharging date previously stored at the previous iteration for a given battery, and comprising a total duration corresponding to a few elementary time intervals. These elementary intervals can be defined in a deterministic manner, according to a principle such as described above, or as a variant in a random manner, so as to exhibit an ever shorter duration at each iteration. These intervals can be distributed in equal share before and after the previously stored recharging date, or in a non-homogeneous manner. Moreover, the various intervals under consideration in the neighbourhood can exhibit equal or different durations. Thus, a solution can consist in randomly selecting a certain (predefined) number of values within the neighbourhood.

A third step E13 then consists of a relocation of the recharging date for the battery under consideration on each of the dates of each elementary interval of the neighbourhood of the battery under consideration, calculated at the previous step. For each of the dates of each elementary interval, the computation of the performance parameter is performed to test the relevance of each of these dates which represent various possibilities. According to a nonlimiting example, mentioned previously, the performance is related to the quantity of energy consumed originating from production by a renewable, for example photovoltaic, energy source. Thus, for each solution envisaged, the energy necessary is computed and, more precisely, the quantity of renewable energy necessary, as a function of an estimation of its production, is computed. In this example, the most efficacious solution is that which uses the largest proportion of energy originating from a renewable energy source. The invention does not pertain specifically to this computation of the most efficacious solution, and other criteria and modes of computation may be employed. The determination of a neighbourhood made explicit in the previous step therefore makes it possible to limit the possibilities tested in this step and to retain a reasonable processing time, while making it possible to improve the solution, so as ultimately to converge to an optimal final solution.

When the whole of this temporal space over a neighbourhood has been tested, a fourth step E14 of storing the most optimal solution is carried out.

These steps are therefore repeated for all the batteries, and make it possible to progressively define ever more optimal solutions. When all the batteries have been thus processed by the previous steps E12 and E13, a step E20 of determining the end of the computation or otherwise is implemented.

The end of the computation can be decided according to several criteria:
The performance of the solution obtained corresponds to a threshold predefined as acceptable; and/or
The number of iterations attains a predefined threshold. This approach allows proper control of the computation time; and/or
The time slicing attains the accuracy predefined in the prior phase; and/or
There has been a predefined number of successive iterations with no improvement in the performance parameter of the solution.

This approach avoids losing time through significant iterations with no improvement in the result; and/or
The duration of a neighbourhood is less than a predefined threshold; and/or
The duration between two intervals distributed around the previously employed recharging date is less than a predefined threshold.

The method thus comprises a step E20 of testing an end-of-computation criterion. Note, the invention does not pertain specifically to this end-of-computation test, and numerous solutions may be chosen, in particular as a function of the desired compromise between computation time and accuracy, by taking into account at least one of the previous criteria given by way of nonlimiting examples.

If the end-of-computation criterion is not attained, the method implements a step of reducing the time span E25, according to the predefined span p mentioned previously, and then recommences a new iteration on all the batteries, according to steps E11 to E14 described hereinabove, with a finer time slicing. As a variant, any mechanism allowing a reduction in the duration of the elementary intervals under consideration can be implemented during this step E25, preferably allowing a reduction in the duration of the intervals according to at least a factor of 2, or indeed for any factor strictly greater than 1.

When the end-of-computation criterion is attained, the method then triggers the recharging of each battery present in the charging system as a function of the recharging date computed for each of them.

This computation is recommenced whenever this is considered to be necessary, in particular on each entry of a battery into the charging system, and optionally also on each exit.

As was previously apparent therefore, the computation is implemented at a given instant on all the batteries present in the charging system, and makes it possible to define an overall solution for future charging of all the batteries. It is therefore an efficacious optimization, which does not merely seek the best solution for a single battery, were it to enter the charging system. As a variant, this computation could be performed on a multitude of batteries, not necessarily all.

According to a variant of the embodiment described hereinabove, if a vehicle charging profile does not correspond to an integer number of periods, it is possible to slightly modify this profile during the initialization step E5, for example by lengthening it or by decreasing it, so as to attain a modified profile representing an integer number of periods.

FIGS. 3 to 11 illustrate the computation described hereinabove, implemented by the algorithm of the method for managing the recharging of batteries, according to a particular scenario by way of example.

In this example, intentionally simplified for reasons of understanding the operating principle, the charging system comprises three batteries to be managed, whose charging profiles 21, 22, 23 are identical and represented by a rectangular shape in the figures. The horizontal length of these rectangles corresponds to the time necessary to obtain the full charging of the battery from its empty state, and the height of these rectangles corresponds to the electrical charging power required for the recharge. Thus, a rectangle corresponds to a very simple charging profile of a battery, which requires the reception of a constant electrical power for a predefined duration, for example 3 kW for 300 minutes. Naturally, the method for managing the recharging of batteries can be implemented with different, more complex, arbitrary charging profile batteries, and with batteries exhibiting mutually differing charging profiles.

The computation parameters, input in the prior step E0, are here the following:
Each vehicle remains in the recharging system the whole day;
The photovoltaic power available in the course of the day is estimated by the curve 25;
The charging system performance criterion employed consists in implementing the charging of each battery using a maximum of photovoltaic power;
Number of periods: 900 minutes;
Accuracy: 15 minutes;
Slicing: 3.

Moreover, the variables to be determined by the computation are in this example the recharging start dates for each of the three batteries.

The initialization step E5 consists in considering the recharging of each battery as soon as they enter the charging system, from the initial instant 0 (the start of the day in this example). This solution is naturally non-optimal since it is clearly apparent that a recharging of the batteries according to this initial solution would require a large power at the start of the day, a significant share of which is beyond the curve 25, thus requiring recourse to additional electrical power, to supplement the available photovoltaic power. On the contrary, a significant share of photovoltaic power would be available subsequently and not used beyond the instant 300.

The first iteration of the computation makes it possible to slice the total duration available (between 0 and 900) into three intervals, each defined respectively by the three initial dates 0, 300 and 600. Subsequently we shall merely define each neighbourhood by a set of dates. These three intervals form the neighbourhoods of the three batteries during this first iteration.

The consideration of the first battery represented by the lower rectangle 21 in FIG. 3 makes it possible to culminate in a new recharging date that is more favourable to the instant 300, as represented by FIG. 4.

In a similar manner, the consideration of the neighbourhood of the second battery, represented by the lower rectangle 22 in the figures, shows that its relocation to a recharge at the instant 300 gives a better solution than that represented in FIG. 4, thus making it possible to opt for an improved solution illustrated by FIG. 5.

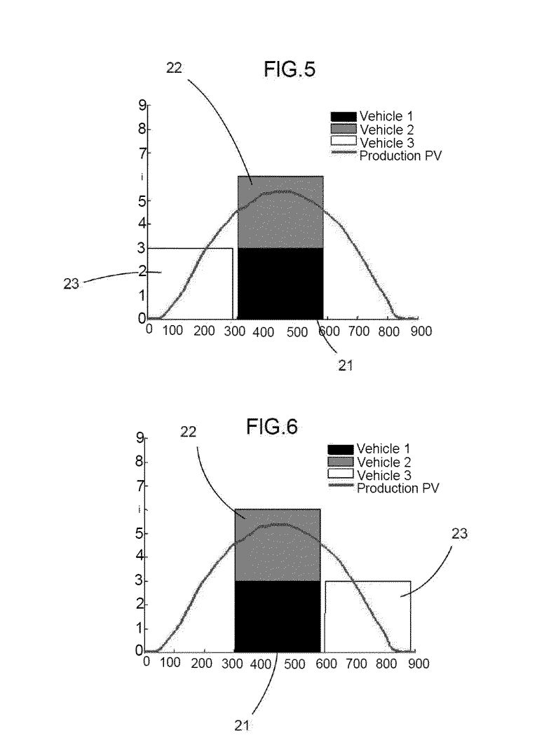

Finally, this first iteration terminates with the relocation of the third battery, represented by the rectangle 23 in the figures. The optimal solution employed is the recharging date 600 for this battery, thus leading us to the recharging configuration of FIG. 6.

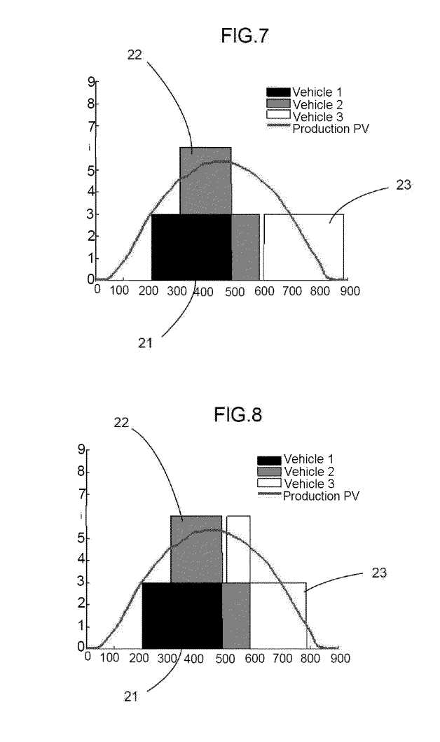

Thereafter, the time span is divided by three, by application of step E25 of the method, and a second iteration is implemented. The neighbourhood of the first two batteries is defined by the dates 100, 200, 300, 400, 500. The optimal position of the first battery is obtained by its recharging date 200, as represented by FIG. 7.

The optimal solution for the second battery is the location 300. It therefore remains unchanged.

The neighbourhood of the third battery becomes 400, 500, 600. Note, the following dates, beyond 600, are not explored since this would entail overstepping the upper limit bound fixed at the instant 900 since the recharge requires a duration of 300 minutes, according to this example.

The optimal position employed is situated for the instant 500, thus yielding the new temporal distribution represented by FIG. 8.

In this exemplary embodiment, the performance coefficient used during the previously detailed step E13 is not specified. However, it is clearly visually apparent in the set of FIGS. 3 to 8 that the evolution of the temporal distribution of the charges of the batteries makes it possible to resort ever more to the photovoltaic power available. It is indeed visually apparent that the charging powers which require recourse to a non-photovoltaic power, and which are illustrated by the areas of the rectangles 21, 22 and 23 which overshoot the curve 25 of available photovoltaic power, are ever smaller.

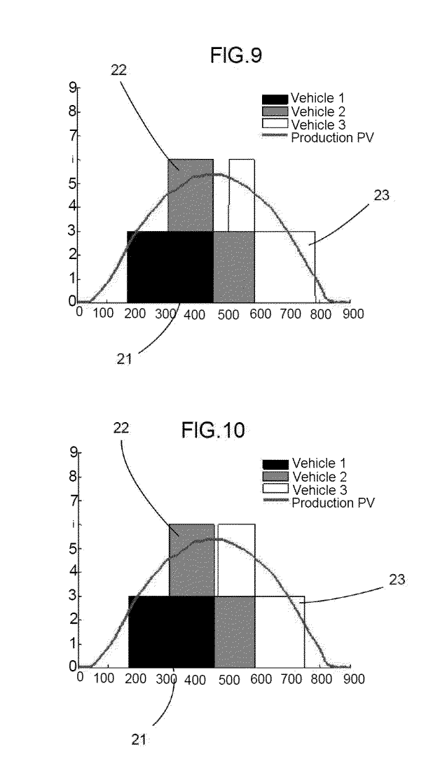

The second iteration having terminated, the time slicing is refined again, by further slicing the elementary time intervals into three, thereby making it possible to define the neighbourhood of the first battery by the start dates 133, 166, 200, 233, 266, distributed around the solution 200 defined at the previous iteration. Testing these various solutions, defined by this neighbourhood, makes it possible to culminate in an improved and optimized choice, represented by FIG. 9, for the new date 166.

For the second battery, the choice remains unchanged and the tests on the neighbourhood defined by the dates 433, 466, 500, 533, 566 for the third battery make it possible to opt for the date 466, and the solution ultimately represented by FIG. 10.

The periods under consideration are again divided into three, thereby making it possible to attain a time slicing into elementary periods of 11 minutes. This value being less than or equal to the accuracy defined in the prior phase, it is therefore the last iteration.

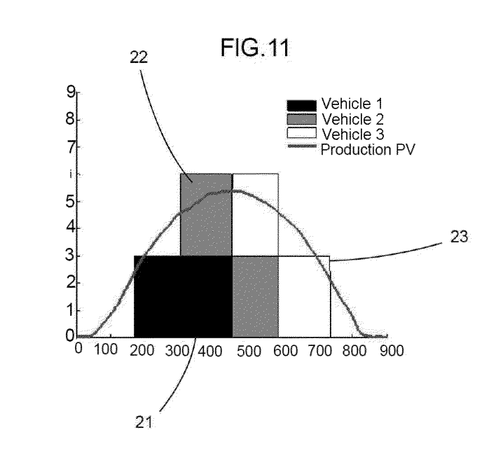

The neighbourhoods of the first and second batteries are then defined by the following respective dates: 144, 155, 166, 177, 188 and 277, 288, 300, 311, 322. The tests on these neighbourhoods do not make it possible to improve the solution defined at the previous iteration, which is therefore retained. Finally, the neighbourhood of the third battery is: 444, 455, 466, 477, 488. It turns out that the choice 455 is optimal, this being represented by FIG. 11.

At the end of this iteration, the end-of-charging criterion being attained (the predefined accuracy in this case), the method halts these iterations and employs this last solution.

The method was explained above on the basis of a performance based on a curve 25 for estimating the photovoltaic power available in the course of the day. On this basis, the method thus computes for each envisaged solution the quantity of energy or of power consumed originating from the estimated photovoltaic production, the performance of a given solution being considered more significant than another if this quantity is more significant.

However, in a similar manner, any other curve may be used. Thus, according to a variant embodiment, provision may for example be made for a shorter period than the reference period of a day, which we call a dummy period since it is defined on the basis of a dummy energy, making it possible to initiate and plan the short-term optimal recharging of the batteries present within the recharging device. This results in a recharging of the batteries at the earliest and in a manner compatible with the available energy, thereby making it possible to keep a subsequent energy reserve in case one or more other batteries should arrive in the course of the day. Moreover, the planning defines an energy consumption curve which best follows, as closely as possible, the profile of the predetermined dummy power curve, according to an optimized distribution. Another curve is thus defined as replacement for the curve 25 illustrated previously, but used in the same manner in the implementation of the method.

Accordingly, the method according to this variant embodiment comprises a first step of determining the energy need Eᵢ(t) of each battery i present in the pool at the instant t. This energy need Eᵢ(t) depends for example on the state of charge of the battery i, which makes it possible to deduce therefrom the energy required to attain its full charge, its particular charging profile, etc. This computation makes it possible to ascertain the total energy need at the instant t under consideration at the level of the recharging device, computed by Σᵢ Eᵢ(t).

During this first step, the forecast energy E_{predicted} which will be produced by the energy sources 5, 6 of the charging system over the day is estimated, on the basis of data of meteorological forecasts or by any other procedure, such as a so-called persistence procedure consisting in reusing the energy production measurements of the previous day, or on the basis of stored curves, such as a seasonality curve. These data can therefore be estimated in a theoretical and/or empirical manner. The forecast or predicted power P_{predicted}(t) at each instant t of the day is thus also estimated. The forecast period will be called the reference period.

Moreover, the forecast energy Eₚₒₒₗₛₜₐₜ which will be consumed by the batteries over the day from the instant t for their recharging is also estimated, for example on the basis of statistical data of energy consumption of the recharging device, on the basis of storage of the past consumptions. These statistical data thus take into account the scheduled frequenting of the car park. They can be separated into several categories to take account of the different nature of very different statistics, such as the week or the week-end.

Note, the entire description considers a day as reference period for the implementation of the method. However, any other reference period is conceivable.

In a second step, the method comprises the computation of a dummy energy E_{dummy}(t), which corresponds to an energy that it is desired to use to meet the need identified in the planning at the instant t, as will be more clearly apparent subsequently.

In this embodiment, this dummy energy is defined by:

$${E}_{dummy} ( t ) = {Σ}_{i} {E}_{i} ( t ) * \frac{{E}_{predicted}}{{E}_{poolstat}}$$

The ratio E_{predicted}/Eₚₒₒₗₛₜₐₜ represents the share of energy that can meet the statistical demand of the batteries. The dummy energy thus defined takes into account both the energy need of the batteries and also the energy a priori actually available to meet it. As a variant, another function might have been defined for the computation of this dummy energy, for example in a simplified manner without taking this ratio into account, that is to say for example by considering that Eₚₒₒₗₛₜₐₜ=E_{predicted}. As a variant, this ratio can also be defined arbitrarily, independently of E_{predicted} and Eₚₒₒₗₛₜₐₜ to adapt the dummy power curve so as to take account of user criteria, through a formula of type:

E_{dummy}(t)=rΣᵢ(t).

For example, if it is known that the pool of batteries is under-dimensioned with respect to the needs, the predicted energy will always be less than the consumed energy: the ratio r will lie between 0 and 1. On the other hand, if it is known that the pool of batteries is overdimensioned with respect to the needs, the predicted energy will always be greater than the consumed energy: the ratio r will be greater than 1. However, a value greater than 2 would not be beneficial in so far as, the pool being overdimensioned to the utmost, it is no longer necessary to use the invention which tends to close the gap between the prediction curve and the consumption curve. Thus, generally, r is chosen between 0 and 2 inclusive.

In a third step, the method determines a dummy power curve, which makes it possible to distribute over time the dummy energy to be used. This step firstly requires the computation of an instant t₀ for which the energy produced by the sources of the recharging device corresponds to half the dummy energy computed in the previous step. The instant t₀ is therefore defined by the following equation:

2[∫₀^{t0}Ppredicted(u)du]−∫₀^{t}Ppredicted(u)du=E_{dummy}

The period from 0 to 2t₀ will be called the dummy period.

Thereafter, the dummy power curve is defined by:

P_{dummy}(t)=P_{predicted}(t) if t≦t₀,

P_{dummy}(t)=min[P_{predicted}(2t₀−t); P_{predicted}(t)] if t₀<t≦2t₀

P_{dummy}(t)=0 if t>2t₀

This approach thus makes it possible to determine a dummy curve of energy production provided by the energy sources 5, 6 of the charging system, which is optimal in the short term to meet the identified need of the pool of batteries or which just suffices to cover this need.

In the particular case for which the dummy energy is greater than the predicted energy, that is to say the energy which will be produced by the energy sources 5, 6 according to a prediction computation, then the dummy curve is chosen equal to the predicted power curve.

Thereafter, the recharging method implements a fourth step of planning the recharging of the batteries of the pool within the dummy power curve defined during the previous step. This planning is then done according to the method described above, this dummy curve replacing the curve 25 illustrated in FIGS. 3 to 11.

1. Method for managing the charging of a pool of batteries on the basis of a charging system comprising several charging terminals supplied electrically from at least one energy production source, wherein the method comprises:
a. initializing a recharging date for each battery of the battery pool, and then, for a battery under consideration in the battery pool:
b. defining a neighbourhood formed by a temporal space comprising a few elementary time intervals extending around a recharging date previously stored for the battery under consideration, each elementary time interval being associated with a recharging date,
c. computing a performance of a new solution obtained by replacing the recharging date previously employed for the battery under consideration with recharging dates of the elementary time intervals included in the neighbourhood defined in the previous step, and then
d. storing a recharging date which gives the best performance subsequent to performing the computation of the previous step and replacing the previously employed recharging date with the new recharging date which gives the best performance,
and then:
e. testing an end-of-computation criterion,
f. if the end-of-computation criterion is not attained, performing a new iteration of steps b to d hereinabove while considering a neighbourhood of reduced duration with respect to the previous iteration for a battery under consideration, the neighbourhood of reducing duration comprising a duration corresponding to elementary time intervals defined so as to form a shorter duration at each iteration.

2. Method for managing the charging of a pool of batteries according to claim 1, wherein steps b to d are repeated for a plurality of the batteries of the pool of batteries.

3. Method for managing the charging of a pool of batteries according to claim 1, wherein at least one of (i) a neighbourhood is a temporal space extending around the recharging date previously stored and comprises fewer than 10 recharging dates to be tested, (ii) the various recharging dates of the neighbourhood are successive and separated according to a given time span, (iii) the various recharging dates of the neighbourhood are chosen randomly in the neighbourhood, and (iv) the various possible charging dates of the neighbourhood are distributed on either side of the previously stored recharging date and comprise the previously stored recharging date.

4. Method for managing the charging of a pool of batteries according to claim 1, comprising computing the performance of a new solution which takes into account at least one of (i) a proportion of energy used originating from one or more sources of renewable energy and (ii) an overall cost of the energy used.

5. Method for managing the charging of a pool of batteries according to claim 4, comprising computing a prediction of renewable energy production by a photovoltaic or wind-driven renewable energy source of the charging system.

6. Method for managing the charging of a pool of batteries according to claim 1, wherein the initialization for initializing a recharging date for each battery of the battery pool consists in choosing as initial value a date of arrival in the charging system of each battery.

7. Method for managing the charging of a pool of batteries according to claim 1, comprising a prior phase of storing all or some of the following parameters:
a number of batteries present in the charging system at a given instant;
a charging profile of each battery;
a state of charge of each battery;
at least one of (i) an earliest and (ii) a latest recharging date for each battery;
a duration, over which the charge of the batteries present is to be optimized;
a number of periods, which allows discretizing time over the duration under consideration;
an accuracy, in the form of an integer number of periods;
a time slicing, which allows a more or less significant slicing of the duration under consideration;
a formula for computing the performance.

8. Method for managing the charging of a pool of batteries according to claim 1, wherein the method comprises:
estimating a future energy production by at least one energy source;
estimating an energy need ΣᵢEi(t) for the recharging of the batteries present in the charging system;
computing a dummy power P_{dummy} which is less than or equal to the predicted power and which meets all or part of the energy need in a dummy period;
planning recharges of the batteries present in the charging system over the dummy period.

9. Method for managing the charging of a pool of batteries claim 1, wherein the test of the end-of-computation criterion comprises all or some of the following tests:
a performance of the solution obtained is greater than or equal to a predefined threshold;
a number of iterations attains a predefined threshold;
a time slicing carried out on the basis of the time span attains a predefined threshold;
a duration of a neighbourhood is less than a predefined threshold;
a duration between two intervals distributed around the previously employed recharging date is less than a predefined threshold;
a number of iterations without improvement of the performance attains a predefined threshold.

10. Method for managing the charging of a pool of batteries according to claim 1, wherein the method thereafter comprises charging each battery of the charging system according to a chosen charging profile, from a start-of-charging date deduced directly or indirectly from the recharging date computed by the method after the end-of-computation criterion is attained.

11. Method for managing the charging of a pool of batteries according to claim 1, wherein steps a to f are implemented with at least one of (i) entry and (ii) exit of a battery of the charging system.

12. Charging system of a pool of batteries comprising several charging terminals supplied electrically from at least one energy production source, comprising a central unit which implements the method for managing the charging of the pool of batteries according to claim 1.

13. Charging system of a pool of batteries according to claim 12, comprising at least one of (i) a solar and (ii) a wind-driven renewable energy production source.

14. Charging system of a pool of batteries according to claim 12, wherein the charging terminals are disposed on parking places for the recharging of a pool of batteries of electric automotive vehicles.

15. Charging system of a pool of batteries according to claim 12, comprising a central server, the central server being linked to the central unit of the charging system by at least one communication means.

16. Charging system of a pool of batteries according to claim 13, wherein the charging terminals are disposed on parking places for the recharging of a pool of batteries of electric automotive vehicles.

17. Charging system of a pool of batteries according to claim 13, comprising a central server, the central server being linked to the central unit of the charging system by at least one communication means.

18. Charging system of a pool of batteries according to claim 14, comprising a central server, the central server being linked to the central unit of the charging system by at least one communication means.

19. Charging system of a pool of batteries according to claim 16, comprising a central server, the central server being linked to the central unit of the charging system by at least one communication means.

20. Method for managing the charging of a pool of batteries according to claim 8, wherein the future energy production is estimated by estimating a predicted energy E_{predicted} and a predicted power P_{predicted}(t) as a function of time t, in the course of a reference period, by the at least one energy production source.
